(19) United States
(12) Patent Application Publication
(10) Pub. No.: US 2017/0161797 A1
(43) Pub. Date: Jun. 8, 2017

(54) Commonality Based Crowd Source Communities

(71) Applicant: Bosch Automotive Service Solutions Inc., Warren, MI (US)

(72) Inventor: James Thomas Fish, Birmingham, MI (US)

(21) Appl. No.: 14/960,855

(22) Filed: Dec. 7, 2015

(51) Int. Cl. G06Q 30/02; H04L 29/08; H04W 4/02; G06Q 50/00

(52) U.S. Cl. CPC G06Q 30/0282; G06Q 50/01; H04L 67/306; H04L 67/22; H04W 4/023

(57) ABSTRACT

A system that allows verified purchasers to communicate with each other and to post on a store's board. The system includes a server for the store which includes various applications that can interact with a wireless device or a connected vehicle. The user of the wireless device or the connected vehicle can use these devices to check-in with the store and become a verified purchaser. Once a verified purchaser, the user can communicate with other verified purchasers of the store.

### FIELD OF THE INVENTION

The present invention relates generally to using crowd source and social networking. More particularly, the present invention relates to using crowd source and social networking to allow communication with other users.

### BACKGROUND OF THE INVENTION

Consumers or individuals in general seek helpful knowledge, advice and counsel to aid in their decision-making when purchasing a product, such as a vehicle or service, such as repairing the vehicle. There are companies such as Yelp™, Trip Advisor™ or Angie's List™ that are often used by the consumers in order to gain knowledge about the particular product or service. However, these companies generate revenue based on advertising or subscription and tend to suboptimize information. That is these companies may rank the product or services based on advertising dollars or subscription amount received from the entity or entities being listed rather than based on consumer opinions.

These companies also allow a consumer to simply post a review about an entity on a company's website even though the consumer may never have visited the entity or purchased a product or service from the entity being reviewed. Further, these companies then can be subjected to “robo check-ins” by an entity that wants to be ranked at the top of the lists so that they can be readily seen by the consumers.

Accordingly, it is desirable to provide a system that verifies the consumer has visited the entity or store and allows consumer to consumer interactions in order to receive unbiased reviews.

### SUMMARY OF THE INVENTION

The foregoing needs are met, to a great extent, by the present invention, wherein in one aspect an apparatus is provided that in some embodiments include a processor-implemented method of linking users programmed in a non-transitory processor-readable medium and to execute on one or more processors of a computer configured to execute the method that includes verifying a first user is a first verified purchaser by determining if the first user has checked-in into a store using a check-in/social media application, receiving a check-in from a second user's device, determining a location of the second user using location information provided by the second user's device global positioning system, verifying the second user as a second verified purchaser due to the check-in from the second user's device, offering the second verified purchaser an ability to communicate with the first verified purchaser, and establishing a communication link between the first and second verified purchasers.

In another embodiment, a computing device that provides a communication link between users includes a processor configured to control functions of the computing device via software and applications, a global positioning system configured to provide a location of the computing device in relation to a store, a wireless interface configured to communicate with a remote device of the store, and a memory in communication with the processor and configured to store an operating system and a plurality of applications, wherein the plurality of applications includes a browser application configured to provide a first browser that interacts with a remote second browser on the remote device of the store, wherein the browser application allows a first user to check-in at the store using the first browser, and a check-in/social media application configured to allow the first user to check-in at the store, wherein once checked-in, the first user is verified as a verified purchaser of the store, and wherein the check-in/social media application allows a communication link between verified purchasers.

In accordance with another embodiment, a computing device that provides a communication link between verified users that includes a processor configured to control functions of the computing device via software and applications, a communication interface configured to communicate with a network, a display engine configured to generate a graphical user interface on a remote device connected to the network, and a memory configured to store an operating system and a plurality of applications, wherein the plurality of applications includes a browser application configured to interact with a remote browser on the remote device, wherein the browser application allows a first user to check-in at a store with the remote browser; and a user/verified purchaser manager configured to track verified purchasers and provides a communication link only between the first user and a second user when both the first and second users are verified purchasers, and wherein verified purchaser have purchased a good or service or has checked-in at the store.

There has thus been outlined, rather broadly, certain embodiments of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates consumers that are located near a store in which goods and services are provided according embodiments of the invention.

FIG. 2A illustrates exemplary components of the wireless device to according embodiments of the invention.

FIG. 2B illustrates exemplary components of the connected vehicle according to embodiments of the invention.

FIG. 3 illustrates exemplary components of a server of a store according to embodiments of the invention.

FIG. 4 illustrates a method for allowing a user to chat with verified purchasers.

### DETAILED DESCRIPTION

The invention will now be described with reference to the drawing figures, in which like reference numerals refer to like parts throughout. Embodiments of the invention allows a user that has been verified, for example, via “check-in” at the store's location or by signing into the website, to post a review or comments on the store's website about the entity or store that the customer has visited. Further, embodiments of the invention allow verified users to communicate directly with each other. Additional verification may be that the user has actually purchased a particular good or service from that entity or store.

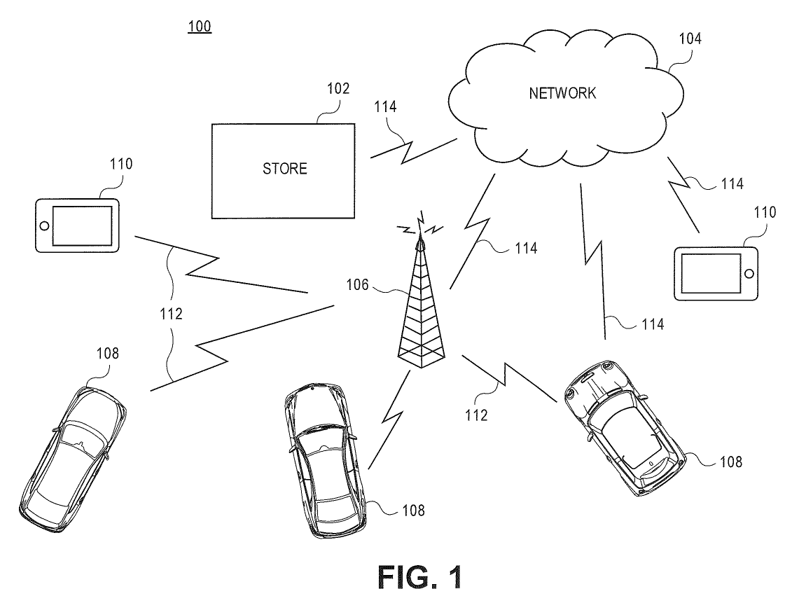

FIG. 1 illustrates consumers that are located near a store 102 in which goods and services are provided according embodiments of the invention. The entity may be a store 102 of any type that provides services and/or goods such as a dealership, repair shop, hospital, clothing store, electronic store, auto-parts store, restaurants, clubs, bars and the like. The store 102 may also be a virtual store, for example, an Internet retailer (https://actron.com/) of diagnostic tools.

Consumers may arrive at the store via a vehicle, such as a connected vehicle (motorcycle, automobile, bicycle, etc.) 108, or by walking or using public transportation. A connected vehicle 108 is capable of communicating with the store 102 or other connected vehicle or wireless devices 110 such as a smart phone, personal digital assistant, videogame console, smart glasses, smart watch, tablet, laptop or the like. The connected vehicle 108 can have a connection 112, which is a wired or wireless connection. Connection 112 can communicate with a cellular tower 106 or a satellite (not shown) or the like. The connected vehicle 108 can have a connection 114 that also a wired or wireless connection. Connection 114 can communicate with a network 104, which may be the Internet, other distributed network, WLAN, LAN, and the like. It should be noted, the connection 114 and connection 112 may be the same or different type of connection from each other. Wired connections may include USB (universal serial bus), FireWire, serial, parallel and the like. Wireless connections may be via Wi-Fi, Bluetooth, Zigbee, near field communications, radiofrequency, satellite, cellular and the like.

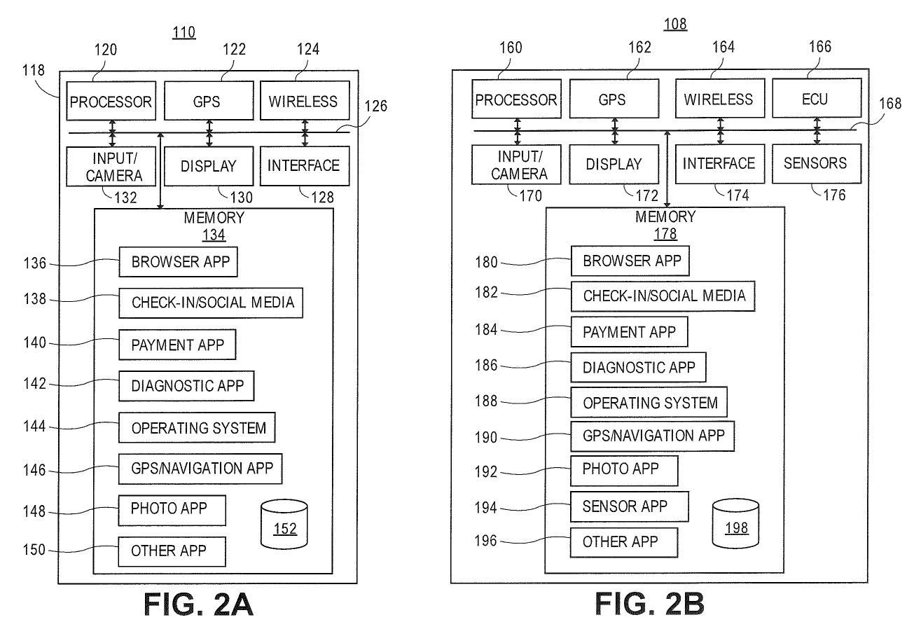

The connected vehicle 108 can be connected to the store 102 and/or the network 104 either automatically such as when the vehicle is within a predetermined range (i.e. 100 ft., 50 ft., 30 ft., 20 ft., 10 ft., 5 ft.) from the store or connected manually by the user. The location of the connected vehicle 108 can be determined using location determination means such as global positioning systems (162 of FIG. 2B).

Further, when the connected vehicle 108 is communicating or connected with the store and/or the network, it is “checked-in” and thus, is one form of verification that the vehicle and indirectly consumer has been to the store or the visited the store's website. Further, in the event the connected vehicle 108 is communicating via a wireless connection directly to the store (server in store) 102, such as Bluetooth, then the connected vehicle would then be deemed to be near or at the location of the store and is another form of verification that the user is a “verified purchaser.”

In another embodiment, verification can also be in the form of vehicle diagnostics being sent to the store using a diagnostic application 142, 186 (FIGS. 2A and 2B). In this embodiment, the store may be a repair shop or an auto-parts store. Vehicle information such as vehicle identification number (VIN), license plate, diagnostic trouble codes, make, model, year and the like may be communicated to the store via connection 114, or connection 112 or both. With the sent vehicle information, the vehicle itself is “checked-in”, thus verifying that the vehicle has been serviced or parts have been purchased at that store. Thus, still another form of verifying the user as a “verified purchaser.”

In still another embodiment, if the consumer did not arrive at the store 102 in the connected vehicle or his vehicle is not capable of communicating via connection 112, 114, the consumer can “check-in” with the store 102 using wireless device 110 and activating a check-in/social media app 138 (FIG. 2) that connects via connection 112 and/or connection 114. “Check-in” can occur when the wireless device 110 is located near or at the store based on location data from the wireless device GPS 122 (FIG. 2A). The consumer can also use a wireless device 110 to “check-in” with the virtual store using the browser app 136 (FIG. 2) or the check-in/social media app 138 that communicates via network 104. The consumer can send identifying information such as name, address, wireless device identifier (phone number, brand, serial number, etc.), or brand, model, and vehicle information (i.e. VIN, license) for the vehicle he owns and the like.

When the consumer is a “verified purchaser” of the goods or services, it lends credibility to the review or comments regarding the goods or services provided for that store. That is, there is a high degree of confidence that the consumer providing the review or comments has actually visited the store and purchased goods and services and is unlikely that the review was done by a “robo check-in” made by an automated service or “professional reviewer” that are paid to provide false reviews on websites. This helps to prevent entities from providing false or misleading reviews (including false star ratings for good service) in order to increase its ranking. That is, verification helps to prevent an automated service from providing high ratings for the store (5 out of 5 stars or 4 out of 5 stars, as an example) when most consumers that actually visited and rated the store as 1 or 2 stars out of 5 stars for poor service or high prices.

FIG. 2A illustrates exemplary components of the wireless device 110 to embodiments of the invention. Wireless device 110 may include a housing 118 that houses components such as a processor 120, global positioning system 122, wireless communicator 124, a bus line 126, an interface 128, a display 130, an input/camera 132, and a memory 134.

The housing 118 may contain all the components therein or have components attached on the outside thereof. The housing 118 may be made of any material including an alloy such as aluminum or an elastomeric material and the like. The processor 120 may be any type of processor including a controller, FPGA (field programmable gate array), ASIC (application specific integrated circuit), microcontroller and the like. The global positioning system (GPS) 122 provides location information (including longitudinal and lateral data) of the wireless device. The location information can be used to verify consumer as a “verified purchaser.” The GPS 122 can be based on satellites, cellular, wireless signals such as Wi-Fi signals, or sensors and the like.

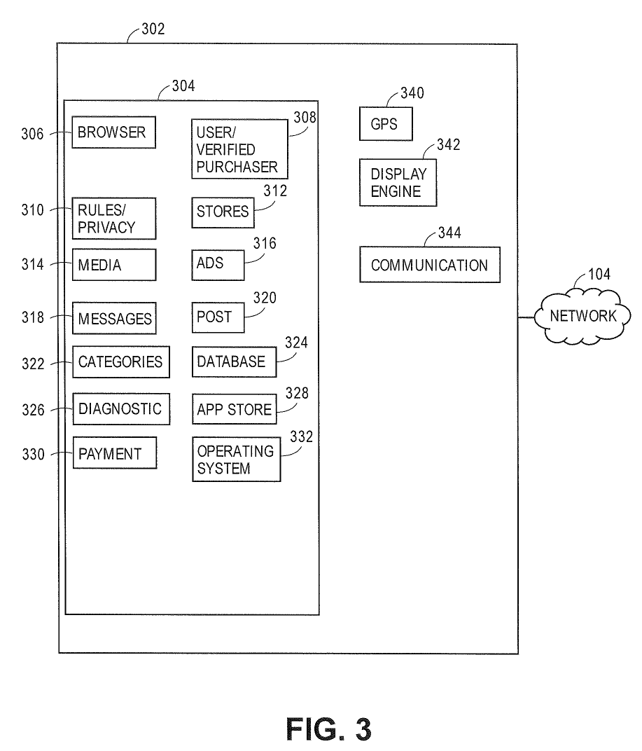

Wireless communicator 124 allows for any type of wireless communication or protocols such as Wi-Fi, Bluetooth, Zigbee, near field communications, radiofrequency, infrared, satellite, cellular and the like. Wireless communicator 124 includes the necessary receivers, transmitters or transceivers and various communication and security protocols in order to allow communication between the wireless device 110 and other devices or network 104. Interface 128 allows additional connections and transmission such as data or information, to and from the wireless device. Additional connections may include USB, FireWire, serial, parallel and the like. Interface 128 can also connect the wireless device 110 to other externally devices including network, scanners, another computing device or wireless device and the like. Display 130 can be any type of display including touchscreen, LCD (TFT, IPS, etc.), OLED, AMOLED, retina display, gorilla glass and the like. Input 132 may be any type of input including directional keys, enter keys, number keys or alphanumeric keys that are either physical or virtual (GUI). Input 132 may also be a camera so that images may be captured and converted to useful information using image or optical recognition software (photo app 148) and the like. In one embodiment, the camera 132 may be used to capture an image of the store 102 so that image recognition software is utilized to identify the store 102 (using database 324 of FIG. 3) in order to verify the “check-in” by the user so that the user is a “verified purchaser.” That is, the capturing and identifying of the store with a captured image allows a degree of confidence that the user was at least near or at the store 102 in order to take the picture. A bus line 126 allows communications between the components of the wireless device 110 including with the memory 134.

The memory 134 stores information, formulas, objects, data, operating system 144, various applications (apps.) and the like, all of which may be displayed on display 130 or an external display. The applications and operating system can be preloaded or downloaded from an application site, such as Apple App Store or Google Play and the like. Examples of applications include browser app 136, check-in/social media app 138, payment app 140, diagnostic app 142, GPS/navigation app 146, photo app 148, and other app 150 that are loaded onto memory 134. These are examples of apps that can be utilized in embodiments of the invention, however, a person skilled in the art would recognize that other apps can be utilized to practice the invention.

Browser app 136 can be any type of browser that allows the consumer to interact with a store's website or webpage and the like. Examples of browsers include Apple Safari, Microsoft Explorer or Edge, Google Chrome and the like. Check-in/social media app 138 allows the user to check-in at a store 102 being visited and interact with the store's server system and other “verified purchasers.” The check-in/social media app 138 allows “verified purchaser” to communicate or interact directly with each other. That's as part of check-in information, the user's devices are registered and communication protocols and applications may be identified so that a “verified purchaser” can talk directly with another “verified purchaser” using similar communication application or protocols, such as a messaging application. The check-in/social media app 138 may be provided as part of a product, such as a phone or diagnostic tool or can be downloaded from an app store. The check-in/social media app 138 may be provided free of charge or be subscription-based including one-time fee, monthly fee, yearly fee or the like.

Since “verified purchasers” have been verified that they have used or purchased a service and/or a product from the store 102, there is a degree of confidence that the reviews, opinions, suggestions or contents (i.e. media content) provided by the “verified purchaser” is relatively unbiased and is not based on a user using false “check-in” such as from a “robo check-in.” The check-in/social media app 138 is configured to determine location of the wireless device (or the connected vehicle) via the GPS 122, for example, and offers an opportunity to chat with “verified purchasers” about their experiences at the store. The check-in/social media app 138 is also configured to identify (or list) the number of verified purchasers that “checked in” and the list can be sorted, for example, based on number of times “checked-in” to the store and/or based on the time of the last “check-in” and/or based on whether they purchased or used a service or product. Other information, regarding the “verified purchasers” that can be sorted, includes information about the product purchased or the product that received the service. For example if the product is a vehicle, then the information may include the vehicle's make, model, year, year purchased, mileage and the like.

Once the “verified purchasers” are identified and selected, the user of the check-in/social media app 138 can communicate directly with the selected “verified purchaser” via a messages application, for example. Further, the user, for example, once “checked-in” can become a “verified purchaser” can see a negative comment on the store's website and contact the verified purchaser who posted the negative comment for additional information about their experience. Additionally, the user can see a “verified purchaser” that had the same service performed, for example, front brakes replacement for a similar vehicle and can inquire on his costs. This allows the user or “verified purchaser” to compare a quote received from the same store to make sure that the costs are comparable. This is particularly helpful if the store is known to underestimate the cost of the repair to get you into the door and then pressures customers to purchase additional services that are not warranted. Further, the check-in/social media app 138 allows the or “verified purchaser” to communicate with other or “verified purchasers” based on criteria such as same make and model of the vehicle or product so that experiences and knowledge may be exchanged between owners of similar vehicles or products.

Payment app 140 such as Apple Pay or Google Pay, can be used to purchase the goods or services at the store 102. The payment app 140 can be linked to a bank account, credit card, debit card, gift card and the like. The payment app 140 also can store account information such as name, address, phone numbers, log-in information and the like. Diagnostic app 142 such as U-Scan™ app, may be used to communicate with a connected vehicle 108 in order to diagnose issues with the connected vehicle. Alternatively, if the vehicle is not a connected vehicle (no wireless communication, for example), then the user can use Actron's CP9599 (from Bosch Automotive Service Solutions Inc, Warren, Mich.) along with the U-Scan™ app in order to diagnose the vehicle.

Operating system 144 is also stored in memory 134. The operating system can be any operating system such as Linux, Windows, Apple iOS or Google Android and the like. The operating system 144 allows the wireless device 110 to interact with the various apps that are stored in the memory 134. Additionally the operating system 144 allows for other functions and components of the wireless device 110 to properly communicate with each other. Also stored in the memory 134, is the GPS/navigation app 146, which may allow the check-in/social media app 138 to determine the location of the wireless device 110 in relation to the store 102. The GPS/navigation app 146 also provides directions to the store 102 to the user.

Photo app 148 allows the images captured by the input/camera 132 to be processed and organized in the memory 134. Photo app 148 also allows for manipulation of the image and performs image or optical recognition of the captured image. Database 152 can include information such as images of stores, products, vehicles, parts, or data to help diagnose the vehicle or other products. The database can include any information that is utilized in the embodiments of the invention. Other app 150 can also be stored in memory 134 and can be any app in order to practice the embodiments of the invention.

FIG. 2B illustrates exemplary components of the connected vehicle 108 according to embodiments of the invention. Connected vehicle 108 includes various components such as a processor 160, GPS system 162, wireless communicator 164, electronic control unit (ECU) 166, the bus line 168, input/camera 170, display 172, interface 174, sensors 176 and memory 178. These components may be similar to components of the wireless device 110.

The processor 160 may be any type of processor including a controller, FPGA (field programmable gate array), ASIC (application specific integrated circuit), microcontroller and the like. The global positioning system (GPS) 162 provides location information (including longitudinal and lateral data) of the connected vehicle 108. The location information can be used to verify users as a “verified purchaser.” The GPS 162 can be based on satellites, cellular, or wireless signals such as Wi-Fi signals, or sensors and the like.

Wireless communicator 124 allows for any type of wireless communication or protocols such as Wi-Fi, Bluetooth, Zigbee, near field communications, radiofrequency, infrared, satellite, cellular and the like. Wireless communicator 124 includes the necessary receivers, transmitters or transceivers and various communication and security protocols for the connected vehicle to communicate with other devices or databases. ECU 166 can control various components of the connected vehicle to ensure optimal engine performance. The ECU 166 communicates with the various sensors 176 in the connected vehicle 108 and also communicates with the on-board diagnostic system (OBD-II) that provides diagnostic information about the connected vehicle to external devices such as the wireless device 110 or the store 102.

Input 170 may be any type of input including directions keys, enter keys, number keys or alphanumeric keys (keys can be physical or virtual). Input 170 may also be a camera so that images may be captured and converted to useful information using image recognition software or optical recognition software (photo app 192) and the like. In one embodiment, the camera 170 (forward facing or rear facing of the vehicle) may be used to capture an image of the store 102 so that image recognition software (linked to database 198, 324) is utilized to identify the store 102 in order to verify the “check-in” by the user so that the user qualifies as a “verified purchaser.” That is, the capturing and identifying of the store with a captured image allows a degree of confidence that the user was at least near or at the store 102.

Display 172 can be any type of display including touchscreen, LCD (TFT, IPS, etc.), OLED, AMOLED, retina display, gorilla glass and the like. The display may also be built-in to the vehicle entertainment system or be a heads-up-display. Interface 174 allows additional connections and transmission such as data or information, to and from the connected vehicle 108. Additional connections may include USB, FireWire, serial, parallel and the like. Interface 174 can also connect the connected vehicle to other externally devices including network, scanners, another computing device or wireless device and the like. Sensors 176 may be any type of sensors including temperature, pressure, brake, throttle position, lane change, and the like. A bus line 168 allows communications between the components of the connected vehicle 108 including the memory 178.

The memory 178 stores various information, objects, data, operating system 188, and various applications (apps.), all of which may be displayed on display 172 or an external display. The applications and operating system can be preloaded or downloaded from an application site, such as Apple App Store or Google Play and the like. Examples of applications include browser app 180, check-in/social media app 182, payment app 184, diagnostic app 186, GPS/navigation app 190, photo app 192, sensor app 194, and other app 196 as loaded onto memory 178. These are examples of apps that can be utilized in various embodiments of the invention, however, a person skilled in the art would recognize that other apps can be utilized to practice the invention. These applications can be the same or different from the applications stored in the wireless device 110.

Browser app 180 can be any type of browser that allows the consumer to interact with a store's website or webpage and the like. Examples of browsers include Apple Safari, Microsoft Explorer or Edge, Google Chrome and the like. Check-in/social media app 182 allows the consumer to check-in at a store 102 that is being visited and interact with the store's server system and other “verified purchasers.” The check-in/social media app 182 allows “verified purchasers” to communicate or interact with each other. That's as part of check-in information, the user's devices are registered and communication protocols and applications may be identified so that a “verified purchaser” can talk directly with another “verified purchaser” using similar communication application or protocols, such as a messaging application. The check-in/social media app 182 may be provided as part of a product, such as a phone or diagnostic tool or can be downloaded from an application site. The check-in/social media app 182 may be provided free of charge or subscription-based including one-time fee, monthly fee, yearly fee or the like.

Since “verified purchasers” have been verified that they have visited, used or purchased a service and/or a product from the store 102, there is a degree of confidence that the reviews, opinions, suggestions or contents (media) provided by the “verified purchaser” is relatively unbiased and is not based on a user that used false “check-in” such as a “robo check-in.” The check-in/social media app 182 is configured to determine location of the connected vehicle 108 via the GPS 162, for example, and offer an opportunity to chat (via messenger app) with “verified purchasers” about their experiences at the store. The check-in/social media app 182 is also configured to identify the number (or lists) of “verified purchasers” that checked in and can be sorted, for example, based on number of times the “verified purchaser” “checked-in” to the store and/or based on the time of the last “check-in” and/or based on whether they purchased or used a service or product. Other information, regarding the verified purchasers that can be sorted, includes information about the product purchased or the product that received the service. For example, if the product is a vehicle, then the information may include the vehicle's make, model, year, year purchased, mileage and the like.

Once the verified purchasers are identified and selected by the user, the user or “verified purchaser” of the check-in/social media app 182 can communicate directly with the selected “verified purchaser.” The “verified purchaser,” for example, can see a negative comment on the store's website and contact the verified purchaser who posted the comment for additional information about their experience. Additionally, user can see a “verified purchaser” that had the same service performed, for example, a major tune up for similar vehicle and can inquire on his costs. This allows the “verified purchaser” to compare a quote received from the same store to make sure that the costs are comparable. This is particularly helpful if the store is known to underestimate the cost of the repair to get you into the door and then pressures customers to purchase additional services that are not warranted. Further, the check-in/social media app 182 allows the “verified purchaser” to communicate with other “verified purchasers” based on criteria such as same make and model of the vehicle or product so that experiences and knowledge may be exchanged between owners of similar vehicles or products.

In another embodiment, the check-in/social media app 182 can be used to identify other people that have similar taste in products or services, such as a vehicle, stereo system, TV, massages, food preferences, hobbies, hair salon, etc. This allows people with similar taste or hobbies to connect with each other and potential find new friends, or even dating partners.

Payment app 184 such as Apple Pay or Google Pay can be used to purchase the goods or services at the store 102. The payment app 184 can be linked to a bank account, credit card, debit card, gift card and the like. The payment app 184 also can store account information such as name, address, phone number, log-in information and the like. Diagnostic app 186 such as U-Scan™ app, may be used to diagnose the connected vehicle 108 or to retrieve diagnostic trouble codes and other diagnostic information and forward it to another computing system in the vehicle or an external device such as the wireless device 110. Alternatively, if the vehicle is not a connected vehicle, then the user can use Actron's CP9599 along with the U-Scan™ app in order to diagnose the vehicle and forward the diagnosis or retrieved diagnostic trouble code (DTC) or diagnostic information to the wireless device 110 or the network 104.

Operating system 188 is also stored in memory 178. The operating system can be any operating system such as Linux, Windows, Apple iOS or Google Android and the like. The operating system 188 allows the connected vehicle 108 to interact with the various apps that are stored in the memory 178. Additionally the operating system 188 allows for other functions and components of the connected vehicle to properly communicate with each other. Also stored in the memory 178, is the GPS/navigation app 190, which may allow the check-in/social media app 182 to determine the location of the connected vehicle 108 in relation to the store 102. The GPS/navigation app 190 also provides directions to the store 102 to the user.

Photo app 192 allows the images captured by the input/camera 170 to be processed and organized in the memory 178. Photo app 192 also allows for manipulation of the image and performs image or optical recognition of the captured image. Database 198, 324 can include information such as images of stores, products, vehicles, parts, or data to help diagnose the vehicle or other products. The database 198 can include any information that is utilized in the embodiments of the invention.

Sensor app 194 allows for interpretation of various sensors that is in a product or the connected vehicle 108. The sensor app 194 can also interact with other app including diagnostic app 186 in order to provide sensor data as a part of the diagnostic. Other app 196 can also be stored in memory 178 and can be any app in order to practice the embodiments of the invention.

FIG. 3 illustrates exemplary components of server 302 of a store 102 according to embodiments of the invention. Major hardware components of the server such as processor, power source, interfaces (input/output), other memories and components that are part of the server 302 are not shown but are known in the art.

Memory 304 may store various information, objects, data, applications and the like. The applications that be stored in the memory 304 may include Browser Manager 306, Users/Verified Purchasers Manager 308, Rules/Privacy Manager 310, Stores Manager 312, Media/Content Manager 314, Ads Generator 316, Messages Manager 318, Post Manager 320, Categories Manager 322, Database 324, Diagnostic Manager 326, Application Store 328, and Payment Manager 330. Other applications may also be stored to practice the embodiments of the invention. These applications may interact with each other in order to function properly. Further, these applications can also interact with check-in/social media app 138, 182 so that the desired functions and operations described herein can be utilized on the wireless device 110 and/or the connected vehicle 108. An operating system 332 is also stored in memory 304.

Browser Manager 306 interacts with the browsers used by the user's device (i.e. wireless device or connected vehicle) such as Apple Safari, Microsoft Explorer or Edge, Google Chrome and the like and also interacts with the various applications discussed herein. The Browser Manager allows the user and/or the server (or Store) owner to perform operations such as controlling the browser content including, posting, messaging, multimedia content and the like. The Browser Manager 306 may interact with the check-in/social media app 138, 182 in order to provide the user with the desired experience. Users/Verified Purchasers Manager 308 can control or catalog the multitude of users including “verified purchaser” via user information including log-in information, location of the user when logged in, confirming that a user is a “verified purchaser,” tracking various products and/or services purchased or used, preferences (mailing, settings, purchases, etc.), payment information, physical addresses, and virtual addresses such as emails, phone numbers and the like. Rules/Privacy Manager 310 may control the various rules settings of the website of the store including controlling different privacy levels set by the user or settings imposed by the website owner (store).

Stores Manager 312 can manage information about the various stores including their location, images of the stores, store hours, products and services provided at each store, contact information of the stores such as addresses, emails, phone numbers, webpages, other social media sites, and the like. Media Manager 314 can control the multimedia information that are being uploaded or downloaded by the user. Multimedia information may include links, news, video files, photographs, audio files (music, sound, etc.) and the like. Ads Generator 316 may control the various ads that may be present on the website including their placement in terms of position and timing. Messages Manager 318 can control the various messages that are being posted and responded to by the various users. Messages Manager 318 may also be a “messenger” system that is separate from the website so that users and “verified purchasers” may communicate with each other as explained herein. By having the “messenger” system separate from the website, this helps to control amount of information that is being processed by the store's website at any given time and may allow for faster real-time messaging to occur.

Post manager 320 can control posting by the user including formatting the posting, length of the posting, moderating the posting, controlling who can post or reply to the posting, and the like. The post manager can limit postings to only “verified purchasers.” Posts can be posted on a virtual blackboard for the store. Categories Manager 322 can control various categories that are displayed on the website or in the check-in/social media app 138, 182. Categories may include notifications, groups, interests, apps, friends, favorites, pages, events, and the like.

Database 324 can be used to store various information and data including pictures, images, media files (video and audio), diagnostic information, user information, posting information, messaging information, store information, rules information, setting information, ads information, categories information, application information, browser information, location information, payment information, and the like. Database 324 may also be accessed via the network 104 by the wireless device 110, the connected vehicle 108 or other external devices. Database 324 can also access other databases via the network 104. Diagnostic Manager 326 can control various diagnostic functions including vehicle diagnostics for vehicles such as the connected vehicle 108 or other products including the wireless device and the like. Diagnostic manager 326 can also interact with a wireless device 110 to diagnose vehicles such as the connected vehicle 108. The diagnostic manager receives vehicle diagnostic information and then can verify that the check-in by the user as being a “verified purchaser.”

App Store 328 can control various apps that can be downloaded to devices such as the wireless device 110 or the connected vehicle 108. Examples of the App Store include Google Play and Apple App Store and the like. Payment Manager 330 allows the user to pay for goods and/or services purchased at the store (physically or virtually) either by entering their own credit card, debit card, gift card and discount codes or interacting with other pay services such as PayPal, Apple pay, Google pay and the like. The Payment Manager can store credit card, debit card, gift card, discount codes, contact information (addresses, phone numbers, emails, etc.) and the like. Operating system 332 stored in the memory can include Apple iOS, Google Android, Windows 10, Linux and the like.

Other components for server 302 can include GPS System 340, display engine 342, and communication interface 344. GPS system 340 can track the various locations of the stores and provide directions to users. Display engine or graphical user interface (GUI) 342 can control display of information on the display 130 of the wireless device 110 or the display 172 of the connected vehicle 108. For example, GUI 342 can control various parts of the browser or check-in/social media app such as profile information, postings, multimedia content and the like. Further, GUI 342 can also interpret the interactions by the user of the wireless device 110 or of the connected vehicle 108 so that requested information or received information are properly processed. Communication interface 344 allows for wired or wireless communication between the server and its components and the network 104. Wired connection may be USB, FireWire, serial, parallel and the like. Wireless communication may include Wi-Fi, Bluetooth, Zigbee, near field communications, radiofrequency, satellite, cellular and the like.

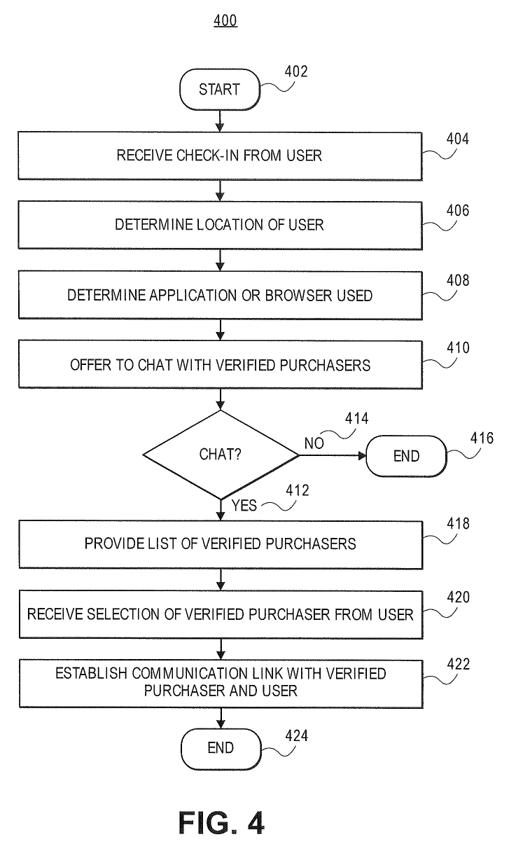

FIG. 4 illustrates a method 400 for allowing a user to chat with “verified purchasers.” The method 400 may be implemented using the various components described herein. At step 402, the method can start. At step 404, the server 302 may receive the “check-in” from the user via, for example, a browser application 136, 180, the check-in/social media application 138, 182 or diagnostic information from diagnostic app 142, 186. At step 406, GPS system 340 of the server may determine location of the user via information from the browser application 136, 180 or the check-in/social media application 138, 182. At step 408, the server can determine which browser or check-in/social media application is being used by the user or the user's device (i.e. wireless device or connected vehicle). If the user is communicating with a browser, a determination of the browser being used may be determined by the Browser Manager 306. Alternatively, if the check-in/social media application 138, 182 is used by the user to check-in, then User/Verified Purchaser Manager 308 can determine the type of social media application (Facebook, Twitter, LinkedIn, etc.) being utilized.

At step 410, the server 302 can offer to the user the ability to chat or communicate with the “verified purchasers.” The offer may be displayed using GUI 342 to display on the display 130 of the wireless device 110 or the display 172 of the connected vehicle 108. The user may select “NO” 414 then process ends at step 416 or the user may select “YES” 412 which then proceeds to step 418. At step 418, GUI 342 may provide a list of “verified purchasers” for selection by the user. The GUI 342 may also allow the user to sort the list via, for example, based on number of times “checked-in” to the store and/or based on the time of the last “check-in” and/or based on whether the “verified purchaser” purchased or used a service or product. Other information, regarding the “verified purchasers” that can be sorted, includes information about the product purchased or serviced or services that were purchased. For example, if the product is a vehicle, then the information may include the vehicle's make, model, year, year purchased, mileage and the like. At step 420, GUI 342 may receive the selection of the “verified purchaser” from whom the user wants additional information or wants to chat therewith. At step 422, a communication link can be established between the “verified purchaser” and the user. The communication may be controlled by the User/verified purchaser Manager 308 or the Messages Manager 318 can allow communication between the “verified purchasers.” At step 424 the process ends when the user and/or the verified purchaser terminates the communication link.

It should be noted that “user” as used herein can also be another “verified purchaser.” Further, aspects of the present invention have been described with respect to block diagrams and/or flowchart illustrations of methods, apparatus (system), and computer program products according to embodiments of the invention. It will be understood that each block of the flowchart illustrations and/or block diagrams, and combinations of blocks in the flowchart illustrations and/or block diagrams, can be implemented by computer instructions that include routines, programs, objects, components, data structures, and so on, that perform particular tasks or implement particular abstract data types. These computer instructions may be provided to a processor of a general purpose computer, special purpose computer, or other programmable data processing apparatus to produce a machine, such that instructions, which execute via the processor of the computer or other programmable data processing apparatus, create means for implementing the functions/acts specified in the flowchart and/or block diagram block or blocks. Additionally, the steps in the flow chart do not have to be performed in the order set forth but can be in any order and be implemented by other components than the ones described.

Although the applications discussed herein are discussed being utilized with vehicle's a vehicle, the applications can be utilized with any product or services including other electronic and mechanical devices and their related services.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A processor-implemented method of linking users programmed in a non-transitory processor-readable medium and to execute on one or more processors of a computer configured to execute the method, comprising:
verifying a first user is a first verified purchaser by determining if the first user has checked-in into a store using a check-in/social media application;
receiving a check-in from a second user's device;
determining a location of the second user using location information provided by the second user's device global positioning system;
verifying the second user as a second verified purchaser due to the check-in from the second user's device;
offering the second verified purchaser an ability to communicate with the first verified purchaser; and
establishing a communication link between the first and second verified purchasers.

2. The linking method of claim 1 further comprising:
providing a list of other verified purchasers by a user/verified purchaser manager should the second verified purchaser wants to communicate with other verified purchasers;
receiving a sorted list of the provided verified purchasers from the second user's device; and
receiving a selected verified purchaser from the second user's device.

3. The linking method of claim 2, wherein the list of verified purchasers is sorted based on a purchased product or service.

4. The linking method of claim 1, further comprising:
determining which browser or check-in/social media application is being used by the second user's device.

5. The linking method of claim 1, wherein receiving the check-in from a second user's device occurs when the second user's device is within a predetermined range from the store or is at the store.

6. The linking method of claim 1, wherein the first user is also a verified purchaser when the first user purchases a good or service at the store.

7. The linking method of claim 1, wherein receiving the check-in from the second user's device further comprising the second user using a check-in/social media app on the second user's device.

8. The linking method of claim 1, wherein the communication link is established only between verified purchasers.

9. The linking method of claim 1, wherein receiving the check-in from the second user's device further comprising receiving, from the second user's device, vehicle diagnostic information via a diagnostic application.

10. The linking method of claim 1, wherein receiving the check-in from the second user's device further comprising receiving an image of the store where the second user's device is located and accessing a database contain a similar image of the store to confirm the check-in.

11. A computing device that provides a communication link between users, comprising:
a processor configured to control functions of the computing device via software and applications;
a global positioning system configured to provide a location of the computing device in relation to a store;
a wireless interface configured to communicate with a remote device of the store; and
a memory in communication with the processor and configured to store an operating system and a plurality of applications, wherein the plurality of applications comprising:
a browser application configured to provide a first browser that interacts with a remote second browser on the remote device of the store, wherein the browser application allows a first user to check-in at the store using the first browser; and
a check-in/social media application configured to allow the first user to check-in at the store, wherein once checked-in, the first user is verified as a verified purchaser of the store, and wherein the check-in/social media application allows a communication link between verified purchasers.

12. The computing device of claim 11, wherein the plurality of applications further comprising:
a diagnostic application that provides vehicle diagnostic information to the remote device of the store, wherein the check-in by the first user also occurs when the vehicle diagnostic information is provided to the remote device of the store.

13. The computing device of claim 11 further comprising:
a camera configured to allows the first user to capture an image of the store and store the image in the memory.

14. The computing device of claim 13, wherein the plurality of applications further comprising:
a photo application that provides the captured store's image by the first user when the first user is located at the store, wherein a database is utilized to confirm the captured store's image and allows the first user to be a verified purchaser.

15. The computing device of claim 13, wherein the plurality of applications further comprising:
a photo application that provides the captured store's image taken by the first user when the first user is located near the store, wherein a database is utilized to identify the captured store's imaged and verify the check-in by the first user.

16. A computing device that provides a communication link between verified users, comprising:
a processor configured to control functions of the computing device via software and applications;
a communication interface configured to communicate with a network;
a display engine configured to generate a graphical user interface on a remote device connected to the network; and
a memory configured to store an operating system and a plurality of applications, wherein the plurality of applications comprising:
a browser application configured to interact with a remote browser on the remote device, wherein the browser application allows a first user to check-in at a store with the remote browser; and
a user/verified purchaser manager configured to track verified purchasers and provides a communication link only between the first user and a second user when both the first and second users are verified purchasers, and wherein verified purchaser have purchased a good or service or has checked-in at the store.

17. The computing device of claim 16, wherein the plurality of applications further comprising:
a diagnostic application that receives vehicle diagnostic information for the store from the first user, wherein the receipt of the vehicle diagnostic information verifies the check-in by the first user.

18. The computing device of claim 16, wherein the plurality of applications further comprising:
a post manager configured to manage posts on a virtual blackboard of the store by allowing posting only by verified purchasers.

19. The computing device of claim 16, wherein the remote device is a smart phone or a connected vehicle.

20. The computing device of claim 16, wherein the user/verified purchaser manager is configured to provide a list of verified purchasers for the first or second verified purchaser to select to communicate with.
